(19) United States
(12) Patent Application Publication
(10) Pub. No.: US 2026/0036993 A1
(43) Pub. Date: Feb. 5, 2026

(54) GLOBAL PATH GENERATION METHOD FOR WIDE-AREA OFF-ROAD ENVIRONMENT, AND GLOBAL PATH GENERATOR FOR THE SAME

(71) Applicant: HANWHA AEROSPACE CO., LTD., Changwon-si (KR)

(72) Inventors: Jae Hyun KIM, Changwon-si (KR); Min Hyeok KWON, Changwon-si (KR); Seung Uk AHN, Changwon-si (KR)

(73) Assignee: HANWHA AEROSPACE CO., LTD., Changwon-si (KR)

(21) Appl. No.: 18/950,931

(22) Filed: Nov. 18, 2024

(30) Foreign Application Priority Data
Aug. 5, 2024 (KR) 10-2024-0104129

(51) Int. Cl. G05D 1/644; G05D 1/246; G05D 1/622; G05D 107/30

(52) U.S. Cl. CPC G05D 1/644; G05D 1/2462; G05D 1/622; G05D 2107/30

(57) ABSTRACT

A global path generation method for a wide-area off-road environment in which an unmanned vehicle performs autonomous driving includes generating an occupancy grid map for a driving area through a sensor, converting the occupancy grid map into a distance map, generating a plurality of nodes by sampling unit grids that are are randomly and uniformly distributed in the driving area of the distance map, generating a plurality of links connecting the plurality of nodes, receiving a destination position of the unmanned vehicle, and generating a global path by connecting optimal links for arriving at the destination position among the plurality of links.

### CROSS-REFERENCE TO RELATED APPLICATION

This application is based on and claims priority under 35 U.S.C. § 119 to Korean Patent Application No. 10-2024-0104129, filed on Aug. 5, 2024, in the Korean Intellectual Property Office, the disclosure of which is incorporated by reference herein in its entirety.

### BACKGROUND

### 1. Field

The present disclosure relates to a global path generation method for a wide-area off-road environment in which an optimal global path may be planned in autonomous driving to a destination in the wide-area off-road environment.

### 2. Description of Related Art

In autonomous driving, an unmanned vehicle and an unmanned robot generate a moving path through route planning and travel along the moving path. The unmanned vehicle and the unmanned robot generate a map capable of identifying an obstacle and a drivable area by scanning a driving environment during driving through a sensor such as LiDAR, etc.

By using the generated map, the unmanned vehicle and the unmanned robot may generate an optimal global path for moving to a destination within the driving area to perform autonomous driving.

However, the unmanned vehicle and the unmanned robot require a lot of memory spaces to manage an occupancy grid map enabling a wide drivable area to be identified, and increase a communication load between software required for management.

In the wide drivable area, a lot of time and work are consumed in calculating a path from current positions of the unmanned vehicle and the unmanned robot to a position of the destination.

Moreover, a moving path planning method using general autonomous driving has a reduced accuracy due to not reflecting the sizes of the unmanned vehicle and the unmanned robot, and when the moving path planning method is used in other platforms, additional tasks may be required.

### SUMMARY

Provided is a global path generation method for a wide-area off-road environment in which a communication load may be reduced and memory use may be reduced in global path generation, and the time and work load required for path calculation may be reduced.

According to an aspect of the disclosure, a global path generation method for a wide-area off-road environment in which an unmanned vehicle performs autonomous driving includes generating an occupancy grid map for a driving area through a sensor, converting the occupancy grid map into a distance map, generating a plurality of nodes by sampling unit grids such that the unit grids are randomly and uniformly distributed in the driving area of the distance map, generating a plurality of links connecting the plurality of nodes, and receiving a destination position of the unmanned vehicle and generating a global path by connecting optimal links for arriving at the destination position among the plurality of links.

The distance map may include a drivable area, an obstacle area, and a collision area formed between the drivable area and the obstacle area.

The plurality of links may not overlap the obstacle area and the collision area.

The sampled unit grid may be a unit grid at a position that secures at least a preset safety distance from an obstacle, by reflecting a size of the unmanned vehicle.

The global path generation method may further include storing, in a data storage, length information of the plurality of links and a minimum distance among connection distances of the plurality of links when the plurality of links pass through at least one node.

The global path generation method may further include forming one global map by connecting a plurality of distance maps in a tile form including up, down, left, and right boundary lines.

The global path generation method may further include forming a plurality of boundary nodes by sampling unit grids, the unit grids being randomly and uniformly distributed among grids spanning a boundary line, in drivable areas of the plurality of distance maps, and connecting, by a link of the plurality of links through a boundary node of the plurality of boundary nodes, one node formed in a drivable area of the distance map in the tile form among the plurality of distance maps to another node formed in a drivable area of another distance map connected to the distance map through the boundary line.

The receiving of the destination position of the unmanned vehicle and the generating the global path by connecting of the optimal links for arriving at the destination position among the plurality of links may include defining, as a cost, a distance from a start node to a goal node via a current node, adding the start node and one or more nodes linked to the start node to a first list, selecting a node having a least cost from the first list and setting the selected node as the current node, removing the current node from the first list and adding the current node to a second list in a state in which the current node is not the goal node, skipping the one or more nodes linked to the current node in a state in which the one or more nodes linked to the current node is in the second list, adding the one or more nodes linked to the current node to the first list setting the cost, and setting a parent node of one or more nodes linked to the current node as the current node, in a state in which the one or more nodes linked to the current node is not in the first list, and updating the cost and setting the parent node as the current node in a state in which the one or more nodes linked to the current node is in the first list and the cost of passing through the current node is less than that of passing through another node.

The global path generation method may further include setting a node closest to the destination position as the goal node.

The global path generation method may further include setting a node closest to a start position of the unmanned vehicle as the start node.

The global path generation method may further include determining whether the first list is empty and terminating a process without generating the global path in a state in which the first list is empty and the goal node is not determined.

The global path generation method may further include generating, as the global path, a path from the start node to the goal node in a state in which the current node is the goal node.

According to another aspect of the disclosure, a global path generator for a wide-area off-road environment in which an unmanned vehicle performs autonomous driving, includes a memory storing instructions, and at least one processor configured to execute the instructions to generate an occupancy grid map for a driving area through a sensor, convert the occupancy grid map into a distance map, generate a plurality of nodes by sampling unit grids, the unit grids being randomly and uniformly distributed in the driving area of the distance map, generate a plurality of links connecting the plurality of nodes, receive a destination position of the unmanned vehicle, and generate a global path by connecting optimal links for arriving at the destination position among the plurality of links.

The distance map may include a drivable area, an obstacle area, and a collision area formed between the drivable area and the obstacle area. The plurality of links may not overlap the obstacle area and the collision area.

The sampled unit grid may be a unit grid a position that secures at least a preset safety distance from an obstacle by reflecting a size of the unmanned vehicle.

The at least one processor may be further configured to execute the instructions to store, in a data storage, length information of the plurality of links and a minimum distance among connection distances of the plurality of links when the plurality of links pass through at least one node.

The at least one processor may be further configured to execute the instructions to form one global map by connecting of a plurality of distance maps in a tile form including up, down, left, and right boundary lines, form a plurality of boundary nodes by sampling unit grids, the unit grids being randomly and uniformly distributed among grids spanning a boundary line, in drivable areas of the plurality of distance maps, and connect, by a link of the plurality of links through a boundary node of the plurality of boundary nodes, one node formed in a drivable area of the distance map in the tile form among the plurality of distance maps to another node formed in a drivable area of another distance map connected to the distance map through the boundary line.

In the receiving of the destination position of the unmanned vehicle and the generating the global path by connecting of the optimal links for arriving at the destination position among the plurality of links, the at least one processor may be further configured to execute the instructions to define, as a cost, a distance from a start node to a goal node via a current node, add the start node and one or more nodes linked to the start node to a first list, select a node having a least cost from the first list and setting the selected node as the current node, remove the current node from the first list and add the current node to a second list in a state in which the current node is not the goal node, skip the one or more nodes linked to the current node in a state in which the one or more nodes linked to the current node is in the second list, add the one or more nodes linked to the current node to the first list, set the cost, and set a parent node of one or more nodes linked to the current node as the current node in a state in which the one or more nodes linked to the current node is not in the first list, and update the cost and setting the parent node as the current node in a state in which the one or more nodes linked to the current node is in the first list and the cost of passing through the current node is less than that of passing through another node.

The at least one processor may be further configured to execute the instructions to set a node closest to the destination position as the goal node, and set a node closest to a start position of the unmanned vehicle as the start node.

The at least one processor may be further configured to execute the instructions to determine whether the first list is empty and terminating a process without generating the global path in a state in which the first list is empty and the goal node is not determined, and generate, as the global path, a path from the start node to the goal node in a state in which the current node is the goal node.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a flowchart of a global path generation method for a wide-area off-road environment, according to one or more embodiments;

FIG. 2 is a block diagram of a global path generation apparatus for a wide-area off-road environment, according to one or more embodiments;

FIG. 3 is a block diagram illustrating a detailed configuration of a controller of FIG. 2, according to one or more embodiments;

FIG. 4 illustrates a state in which an occupancy grid map is generated, according to one or more embodiments;

FIG. 5 illustrates a state in which an occupancy grid map is converted into a distance map, according to one or more embodiments;

FIG. 6 illustrates a state in which a plurality of nodes are generated in a driving area of a distance map, according to one or more embodiments;

FIG. 7 illustrates a state in which a plurality of links that connect a plurality of nodes are generated, according to one or more embodiments;

FIG. 8A illustrates a state in which a plurality of boundary nodes are generated by sampling unit grids such that the unit grids are randomly and uniformly distributed among grids spanning a boundary line, according to one or more embodiments;

FIG. 8B illustrates a state in which a plurality of links connecting the plurality of boundary nodes of FIG. 8A are generated, according to one or more embodiments;

FIG. 9 illustrates a state in which a global path is generated by connecting optimal links for arriving at a destination position from a current position of an unmanned vehicle, according to one or more embodiments; and

FIG. 10 is a flowchart of detailed operations for global path generation according to one or more embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” and “at least one of . . . ” includes any and all combinations of one or more of the associated listed items. For example, “at least one of A or B” may include only A, only B, or both A and B.

The disclosure may have various modifications thereto and various embodiments, and thus particular embodiments will be illustrated in the drawings and described in detail in a detailed description. It should be understood, however, that this is not intended to limit the disclosure to a particular embodiment, and should be understood to include all changes, equivalents, and alternatives falling within the spirit and scope of the disclosure. To describe the disclosure, the same component, even when shown in different embodiments, will be denoted by the same reference numeral.

Hereinafter, embodiments of the disclosure will be described in detail with reference to the accompanying drawings, and in description with reference to the drawings, the same or corresponding components are given the same reference numerals, and redundant description thereto will be omitted.

In the following embodiments, the terms such as first, second, etc., have been used to distinguish one component from other components, rather than limiting.

In the following embodiments, singular forms include plural forms unless apparently indicated otherwise contextually.

In the following embodiments, the terms “include”, “have”, or the like, are intended to mean that there are features, or components, described herein, but do not preclude the possibility of adding one or more other features or components.

In the drawings, the size of components may be exaggerated or reduced for convenience of description. For example, the size and thickness of each component shown in the drawings are shown for convenience of description, and thus the disclosure is not necessarily limited to the illustration.

When a certain embodiment may be implemented otherwise, a particular process order may be performed differently from the order described. For example, two processes described in succession may be performed substantially simultaneously, or may be performed in an order reverse to the order described.

The term used herein is used to describe particular embodiments, and is not intended to limit the disclosure. Herein, it should be understood that the term “include”, “have”, or the like used herein is to indicate the presence of features, numbers, steps, operations, components, parts, or a combination thereof described in the specifications, and does not preclude the presence or addition of one or more other features, numbers, steps, operations, components, parts, or a combination thereof.

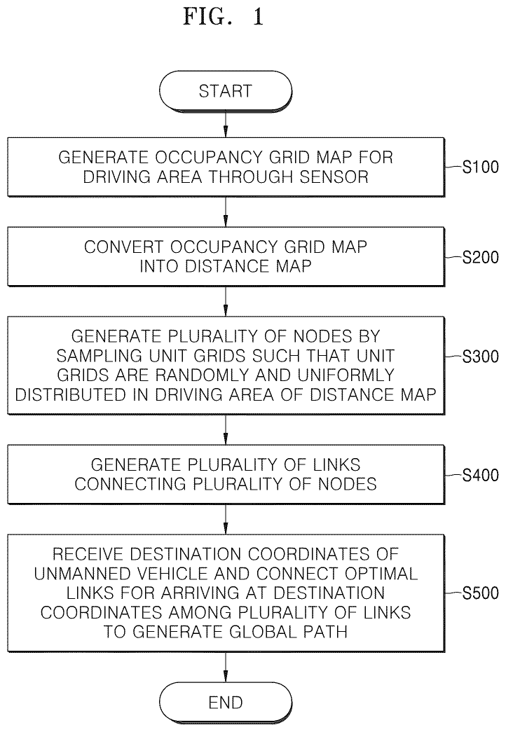

Hereinafter, referring to FIGS. 1 to 9, a global path generation method for a wide-area off-road environment according to one or more embodiments and a global path generation apparatus for a wide-area off-road environment will be described.

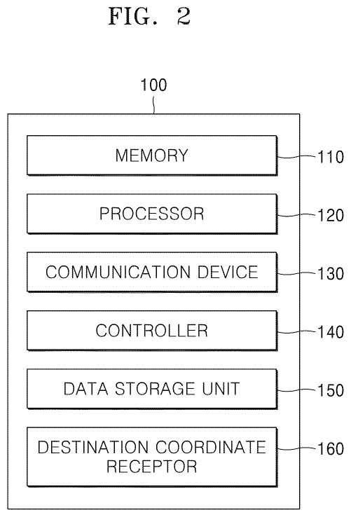

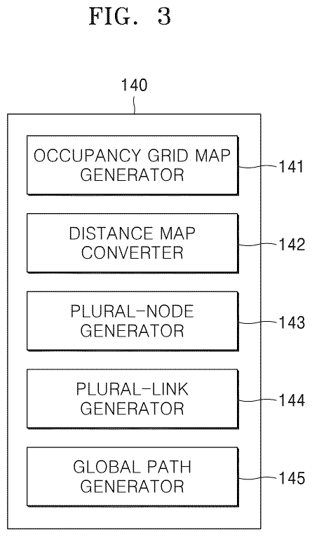

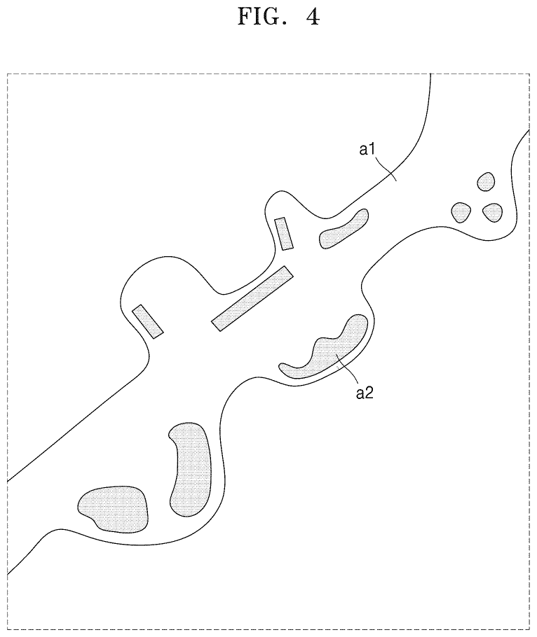

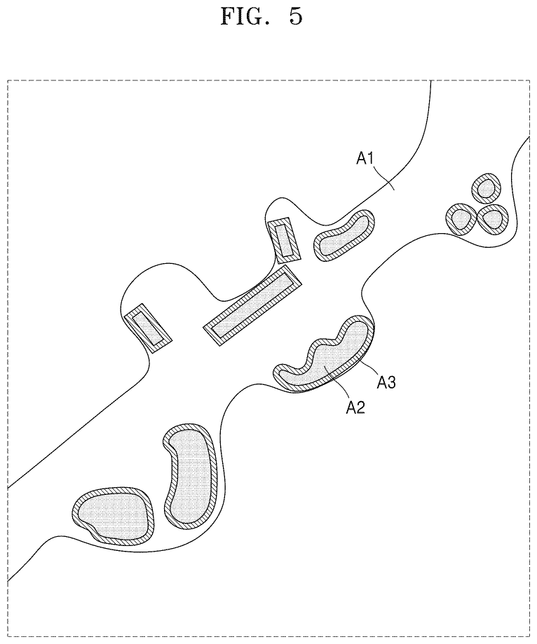

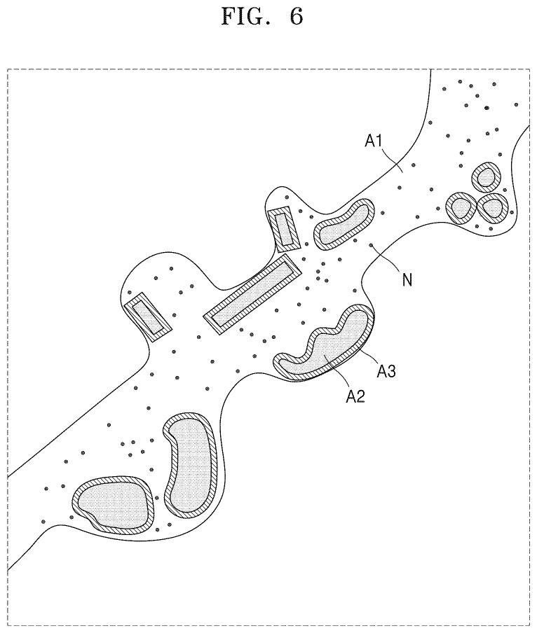

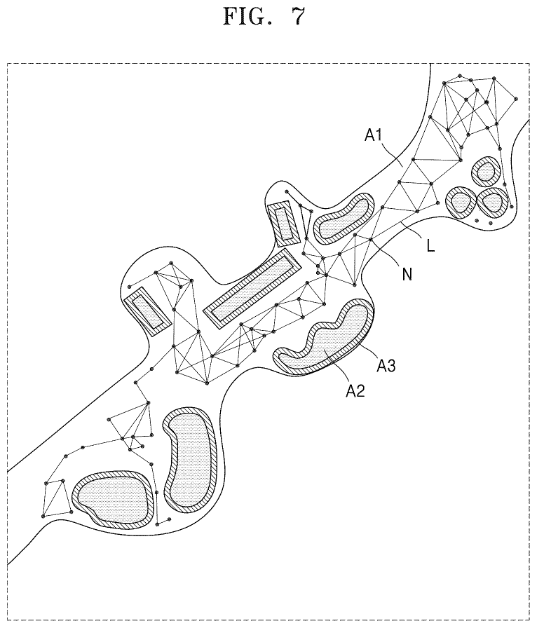

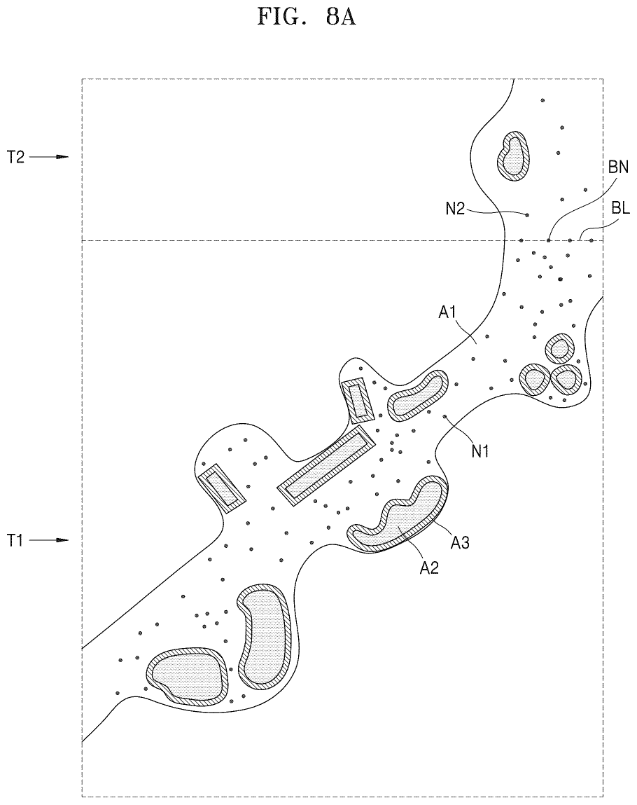

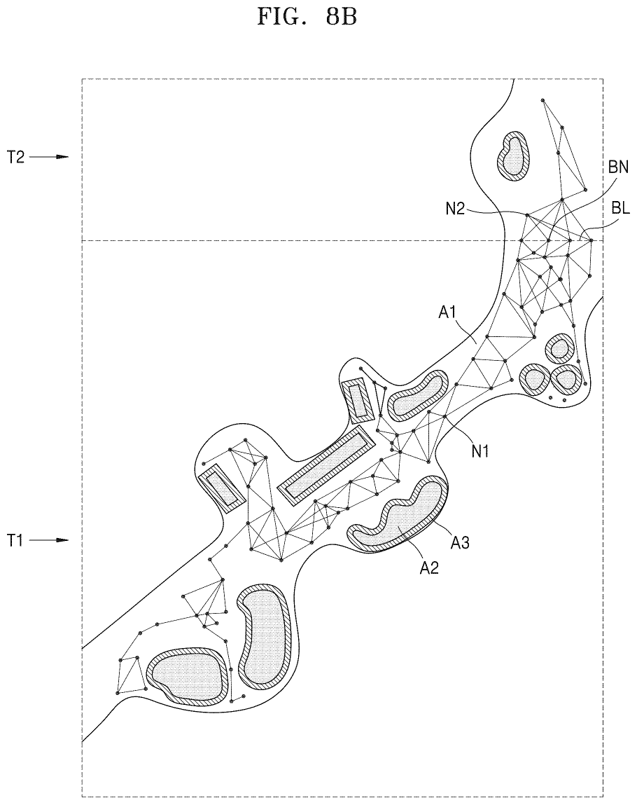

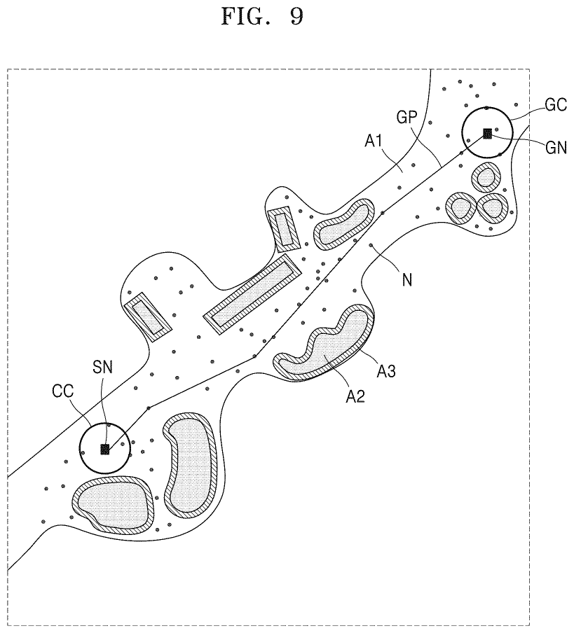

FIG. 1 is a flowchart of a global path generation method for a wide-area off-road environment, according to one or more embodiments. FIG. 2 is a block diagram of a global path generation apparatus for a wide-area off-road environment, according to one or more embodiments. FIG. 3 is a block diagram illustrating a detailed configuration of a controller of FIG. 2. FIG. 4 illustrates a state in which an occupancy grid map is generated, according to the one or more embodiments. FIG. 5 illustrates a state in which an occupancy grid map is converted into a distance map, according to the one or more embodiments. FIG. 6 illustrates a state in which a plurality of nodes are generated in a driving area of a distance map, according to the one or more embodiments. FIG. 7 illustrates a state in which a plurality of links that connect a plurality of nodes are generated, according to the one or more embodiments. FIG. 8A illustrates a state in which a plurality of boundary nodes are generated by sampling unit grids such that the unit grids are randomly and uniformly distributed among grids spanning a boundary line, according to the one or more embodiments. FIG. 8B illustrates a state in which a plurality of links connecting the plurality of boundary nodes of FIG. 8A are generated. FIG. 9 illustrates a state in which a global path is generated by connecting optimal links for arriving at a destination position from a current position of an unmanned vehicle, according to the one or more embodiments.

Referring to FIGS. 1 to 9, a global path generation method for a wide-area off-road environment may include operation S100 of generating an occupancy grid map for a driving area through a sensor, operation S200 of converting the occupancy grid map into a distance map, operation S300 of generating a plurality of nodes by sampling unit grids such that the unit grids are randomly and uniformly distributed in a driving area of the distance map, operation S400 of generating a plurality of links connecting the plurality of nodes, and operation S500 of receiving a destination position of the unmanned vehicle and generating a global path by connecting optimal links for arriving at the destination position among the plurality of links.

The global path generation method for the wide-area off-road environment according to the one or more embodiments may include operation S100 of generating an occupancy grid map for a driving area through a sensor. The occupancy grid map is shown in FIG. 4. The occupancy grid map may indicate an occupancy state of each unit grid cell space having a specific size on a map, based on map data obtained using LIDAR, an ultrasonic sensor, etc., included in an unmanned vehicle. The occupancy state of the space may be expressed differently for an empty area and an occupied area. The controller 140 may store the map data obtained through the LiDAR, the ultrasonic sensor, etc., in a data storage 150. The controller 140 may generate the occupancy grid map through the map data.

Referring to FIG. 4, a first area a1 may indicate an empty area, and a second area a2 may indicate an occupied area. The occupancy grid map may be updated by the controller 140 in real time according to a moved position of the unmanned vehicle as the unmanned vehicle is moved by autonomous driving.

According to the one or more embodiments, the global path generation method may include operation S200 of converting the occupancy grid map into a distance map. The distance map according to the one or more embodiments is shown in FIG. 5. The distance map according to the one or more embodiments may reflect the size of the unmanned vehicle. The distance map may be divided into a drivable area A1, an obstacle area A2, and a collision area A3 that is an edge area between the drivable area A1 and the obstacle area A2, based on the size of the unmanned vehicle. The obstacle area A2 may refer to an area occupied by an obstacle. The collision area A3 may be an area where the unmanned vehicle may collide with the obstacle in the obstacle area A2 when entering the collision area A3, considering the size of the unmanned vehicle. The controller 140 may convert the occupancy grid map into the distance map.

As such, by converting the grid map into the distance map through distance transform to reflect the size of the unmanned vehicle, an area in which the unmanned vehicle may move may be set in a part having no interference with an obstacle, thereby preventing the unmanned vehicle from colliding with the obstacle.

According to the one or more embodiments, the global path generation method may include operation S300 of generating a plurality of nodes by sampling unit grids such that the unit grids are randomly and uniformly distributed in the driving area of the distance map. The controller 140 may generate the plurality of nodes by sampling the unit grids such that the unit grids are randomly and uniformly distributed in the driving area of the distance map.

Specifically, grids on the distance map may be randomly sampled (i.e. selected) through uniform distribution. Among the sampled grids, grids with distance values of at least a safety distance reflecting the size of the unmanned vehicle may be filtered. In each filtered grid, a node may be generated.

Referring to FIG. 6, in the filtered map, a node N on the filtered grid may exist in the drivable area A1. The nodes N filtered in this way may become path points through which the unmanned vehicle may travel. The controller 140 may store position information of the filtered nodes N and a distance between the nodes N in the data storage 150.

According to the one or more embodiments, the global path generation method may include operation S400 of generating the plurality of links connecting the plurality of nodes. Details about generation of the plurality of links L are shown in FIG. 7. The controller 140 may generate the plurality of links connecting the plurality of nodes.

The controller 140 may generate a link that is a straight path between nodes. In this case, the link may be a straight line that does not overlap the collision area A3 and the obstacle area A2.

The controller 140 may store, in the data storage 150, information about a length of the link, the minimum distance between at least one node through which the link connecting one node to the other node passes when the link passes through several nodes, and the at least one node through which the link passes so as to have the minimum distance.

That is, the global path generation method according to the one or more embodiments may further include storing, in the data storage, length information of the link and the minimum distance among connection distances of the links when the links pass through at least one node.

By using the minimum distance, the controller 140 may generate the minimum distance that reflects the changed size of the unmanned vehicle when the size of the unmanned vehicle is changed.

Herein, nodes N connected through the link may be movable nodes N, and all the nodes N may have information about the nodes N connected through the link and information about the connected links L.

According to the one or more embodiments, the global path generation method may further include forming one global map through a connection of a plurality of distance maps in a tile form having up, down, left, and right boundary lines.

FIGS. 8A and 8B illustrate a first distance map T1, a second distance map T2, and connection between the first distance map Tl and the second distance map T2 through a boundary line BL.

In this case, the global path generation method may include sampling unit grids such that the unit grids are randomly and uniformly distributed among grids spanning the boundary line BL in the drivable area A1 of the plurality of distance maps, i.e., a plurality of tile maps to form a plurality of boundary nodes BN.

The global path generation method may further include connecting, through the boundary node BN by a first link and a second link, a first node N1 formed in the drivable area A1 of the first distance map T1 in a tile form among the plurality of distance maps to a second node N2 formed in the drivable area A1 of the second distance map T2 connected through the boundary line BL.

As such, internal nodes in the plurality of distance maps in a tile form are linked to each other, but the distance maps are not linked to each other such that the controller 140 may perform sampling in a uniform distribution manner on an edge between adjacent distance maps, filter a node in a drivable area to convert the same into an edge node, and store the boundary node in the data storage 150.

Nodes on each distance map may be linked to edge nodes, enabling a path to be generated between distance maps. FIG. 8B shows a completed node-link map. The completed node-link map may be in the form of a graph having an edge and a vertex. Each node may be a path point on a path, and a link may be a moving path of the unmanned vehicle. The controller 140 may identify a distance map in each tile form based on coordinates of a bottom left point that is the origin of a coordinate system. By using the origin of the coordinate system, each distance map may be identified and may be individually managed. Other coordinates than those of the bottom left point may be set as reference coordinates.

According to the one or more embodiments, a distance map in a tile form may be defined by not only a tile form such as a square, a rectangle, etc., but also shapes of other figures, e.g., a triangle, a hexagon, etc., and various sizes.

The distance map according to the one or more embodiments may be implemented as a topological map such that a global path may be generated focusing on a link relationship between nodes without using position information or distance information of an actual space.

A node according to the one or more embodiments may not be generated through random sampling and may be generated based on a distance from an obstacle.

Referring to FIGS. 2 and 3, the global path generation apparatus 100 for the wide-area off-road environment according to the one or more embodiments may include a memory 110, a processor 120, a communication device 130, a controller 140, a data storage 150, and a destination coordinate receptor 160.

The controller 140 may include a memory 110, a processor 120, and a communication device 130. Herein, it may be understood that operations, commands, control, etc., performed by the controller 140 may be performed by the processor 120 that executes a command or an instruction stored in the memory 110 described below, and data or information generated by the processor 120 may be transmitted to an external device by the communication device 130.

The memory 110 may store data supporting various functions of the controller 140. The memory 110 may store a number of application programs or applications driven by the controller 140, and data and commands for operations of the controller 140. An application program may be stored in the memory 110 and installed in the controller 140 and may be driven by the processor 120 to perform an operation (or function) of the controller 140.

The processor 120 may execute an instruction stored in the memory 110 to control other components. The processor 120 may execute an instruction stored in the memory 110. The processor 120 may perform operations and control other devices. The processor 120 may mainly mean a central processing unit (CPU), an application processor (AP), a graphics processing unit (GPU), etc.

The processor 120 may generate an occupancy grid map for a driving area through a sensor. The processor 120 may convert the occupancy grid map into a distance map. The processor 120 may generate a plurality of nodes by sampling unit grids such that the unit grids are randomly and uniformly distributed in the driving area of the distance map. The processor 120 may generate a plurality of links connecting the plurality of nodes. The processor 120 may receive destination coordinates of the unmanned vehicle and connect optimal links for arriving at the destination coordinates among the plurality of links to generate a global path.

The communication device 130 may perform a wired communication function with other components or perform wireless communication via an antenna. Wireless communication may mean communication with communication facilities previously installed by common carriers through a wireless communication network using frequencies of the communication facilities. Alternatively, wireless communication may mean short-range communication such as Bluetooth, Bluetooth Low Energy (BLE), beacon, radio frequency identification (RFID), near field communication (NFC), infrared data association (IrDA), ultra wideband (UWB), ZigBee, etc.

The communication device 130 may receive driving map information according to an off-road environment in real time through communication with LiDAR, ultrasonic sensors, etc. The communication device 130 may transmit the received real-time driving map information to the controller 140.

According to the one or more embodiments, the controller 140 may include an occupancy grid map generator 141. The occupancy grid map generator 140 may generate an occupancy grid map for a driving area through a sensor.

The controller 140 may include a distance map converter 142. The distance map converter 142 may convert the occupancy grid map into a distance map.

The controller 140 may include a plural-node generator 143. The plural-node generator 143 may generate a plurality of nodes by sampling unit grids such that the unit grids are randomly and uniformly distributed in the driving area of the distance map.

The controller 140 may include a plural-link generator 144. The plural-link generator 144 may generate a plurality of links connecting the plurality of nodes.

The controller 140 may include a global path generator 145. The global path generator 145 may receive destination coordinates of the unmanned vehicle and connect optimal links for arriving at the destination coordinates among the plurality of links to generate a global path.

According to the one or more embodiments, the global path generation method may include operation S500 of receiving destination coordinates GC of the unmanned vehicle and connecting optimal links for arriving at the destination coordinates GC among the plurality of links to generate a global path. This operation will be described in detail below.

As such, the global path generation method for a wide-area off-road environment and the global path generation apparatus for a wide-area off-road environment according to embodiments of the disclosure may minimize the amount of communication between software and the amount of computations and computation time for generating an optimal path when generating a global path in the wide-area environment in kilometers (km), thereby preventing damage to a memory, a processor, and a communication device due to overload and more quickly generating an optimal global path.

Specifically, an occupancy grid map may be managed in the form of a plurality of tile maps, thereby reducing a communication load and the use of a memory.

Moreover, by converting the grid map into the distance map through distance transformation to reflect the size of the unmanned vehicle, an area in which the unmanned vehicle may move may be set in a part having no interference with an obstacle.

Furthermore, as one global map is formed by connecting boundary lines of tile maps converted into the distance map, an optimal global path may be generated on the entire global map.

By connecting node-link maps of respective tile maps through edge nodes, path planning between tile maps may be possible through a boundary portion of each tile map.

Through a series of sequences connecting the plurality of links between start coordinates and destination coordinates, an optimal global path may be easily generated.

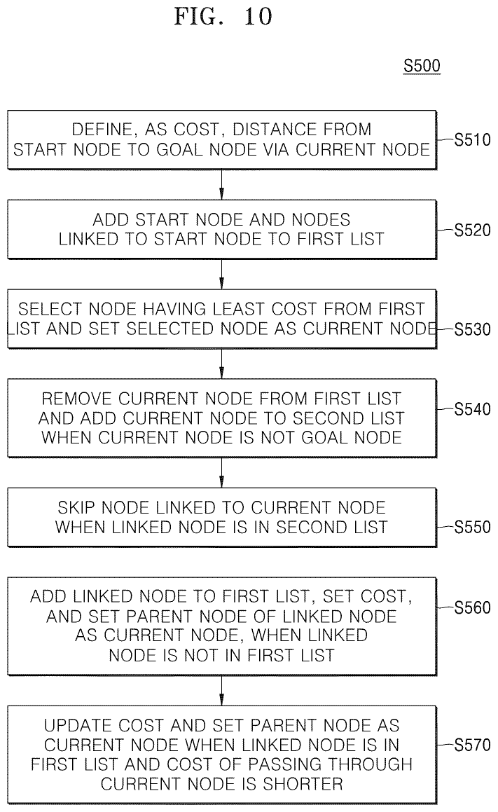

Hereinafter, with reference to FIGS. 9 and 10, detailed operations for global path generation according to one or more embodiments are described.

FIG. 9 illustrates a state in which a global path is generated by connecting optimal links for arriving at a destination position from a current position of an unmanned vehicle, according to the one or more embodiments. FIG. 10 is a flowchart of detailed operations for global path generation according to one or more embodiments.

Referring to FIGS. 9 and 10, a global path generation operation according to one or more embodiments may include an operation of receiving a destination position of an unmanned vehicle and connecting optimal links for arriving at a destination position among the plurality of links to generate a global path.

Operation S500 may include operation S510 of defining, as a cost, a distance to a goal node GN, via a current node, from a start node SN, operation S520 of adding the start node SN and nodes linked with the start node to a first list, operation S530 of selecting a node having the least cost from the first list and setting the selected node as a current node, operation S540 of removing the current node from the first list and adding the current node to a second list when the current node is not the goal node GN, operation S550 of skipping a node linked to the current node when the linked node is in the second list, operation S560 of adding the linked node to the first list, setting the cost, and setting a parent node of the linked node as the current node, when the linked node is not in the first list, and operation S570 of updating the cost and setting the parent node as the current node when the linked node is in the first list and the cost of passing through the current node is less than a cost of passing through the previously found start node SN (i.e. shorter). The controller 140 may control the foregoing operations through the global path generator 140 to generate a final global path.

In this case, the global path generation method may further include setting a node closest to the destination position GC as the goal node GN. The global path generation method may further include setting a node closest to the start position SC as the start node SN. The destination position GC and the start position SC may be set as an area having a range rather than specific spots. Thus, when the unmanned vehicle is determined as being in a specific range, a node positioned at the center portion of the specific range may be set as the start node SN. When the unmanned vehicle determines the specific range as the destination position, a node positioned at the center portion of the specific range may be set as the destination position GC.

Herein, the destination position GC may be received through a destination coordinates reception unit 160.

The global path generation method may further include determining whether the first list is empty and terminating a process without generating a global path GP when the first list is empty and the goal node GN has not been found at that time.

The global path generation method may further include generating a path from the start node to the goal node GN as the global path GP when the current node is the goal node GN.

According to the one or more embodiments, the controller 140 of the global path generation apparatus 100 for a wide-area off-road environment may receive position coordinates of a destination. A node closest to the input coordinates of the destination may be searched for from a node list and designated as the goal node GN. The controller 140 may perform calculation of the optimal global path GP with the goal node GN as the destination.

The node closest to the start position SC of the unmanned vehicle may be searched for from the node list and stored as the start node SN. The start node SN and the node linked to the start node may be added to an open list that is the first list. A node having the least cost defined as the sum of a distance from the start node to the current node and a distance from the current node to the goal node may be searched for from the first list, and may be added to a closed list that is the second list. In this case, the start node and the current node may be removed from the open list and the following process may be repeated while the open list is not empty.

Specifically, the node having the least cost may be selected from the first list, may be added to the second list, and then may be removed from the open list. Thereafter, a node linked to the node selected in the foregoing operation may be searched for. The searching process may include adding, except for a node in the second list among the linked nodes, a node to the first list when the node is not in the first list.

When the linked node is already in the first list, it may be determined whether a distance from the start node to the current linked node is less than a distance from the previously found start node to the linked node in case of movement from the current node to the linked node. When the distance to the current linked node is less than a distance from the previously found start node to the linked node, it may be updated as a distance of the node. When the goal node is reached by repeating the foregoing process, an optimal path may be configured by tracing previous nodes in the second list in reverse order from the start node, and a global path may be finally generated.

More specifically, a distance from the start node to the goal node via the current node may be defined first as a cost in operation S510. In this case, the open list that is the first list and the closed list that is the second list may be initialized together.

Thereafter, the start node and nodes linked to the start node may be added to the first list, in operation S520. Herein, a node having the least cost may be selected from the first list and may be set as the current node, in operation S530.

In this case, the controller 140 may determine whether the current node is a goal node, and remove the current node from the first list and add the current node to the second list when the current node is not the goal node, in operation S540. When the current node is the goal node, the corresponding path may be generated as a global path.

The global path generation method may further include repeating operations S530 and S540 for all nodes linked to the current node.

Herein, when the node linked to the current node is in the second list, the corresponding node may be ignored, i.e., skipped, in operation S550. When the linked node is not in the first list, the linked node may be added to the first list, the cost may be set, and a parent node of the linked node may be set as the current node, in operation S560.

In this case, the parent node may be a node that passes immediately before a node for which the path is set forward. Herein, the linked node may be added to the first list, and a distance from the start node to the current node and a distance from the current node to the goal node may be set and added as a cost.

However, when the linked node is in the first list and the cost of passing through the current node is less than that of passing through another node, the cost of passing through the current node may be updated as the corresponding cost and the parent node may be set as the current node in operation S570. The updated cost may be a distance from the start node to the current node.

The global path generation method may further include configuring an optimal path by tracing previous nodes in the second list in reverse order from the start node when the goal node is reached through the foregoing operations.

As described above, a scheme to add the optimal global path based on a node-link map may be implemented.

As such, the disclosure has been described with reference to the embodiments shown in the drawings, but this is only an example embodiment. It would be fully understood by those of ordinary skill in the art that various modifications and other equivalent embodiments are possible from the embodiments.

Specific technical details described in the embodiments are examples, and do not limit the technical scope of the embodiments. In order to briefly and clearly describe the description of the disclosure, the description of conventional general techniques and configurations may be omitted. Connections of lines or connection members between components shown in the drawings are illustrative of functional connections and/or physical or circuit connections, and in practice, may be expressed as alternative or additional various functional connections, physical connections, or circuit connections. In addition, when there is no specific mentioning, such as “essential” or “important”, it may not be a necessary component for the application of the disclosure.

A designator “the” or similar designators described in the description and the claims may refer to both singular and plural, unless otherwise specifically limited. In addition, when the range is described in the embodiments, the range includes the disclosure to which an individual value falling within the range is applied (unless stated otherwise), and is the same as the description of an individual value constituting the range in the description of the disclosure. When there is no apparent description of the order of operations constituting the method according to the embodiments or a contrary description thereof, the operations may be performed in an appropriate order. However, the disclosure is not necessarily limited according to the describing order of the operations. The use of all examples or exemplary terms (for example, etc.) in the disclosure are to simply describe the disclosure in detail, and unless the range of the disclosure is not limited by the examples or the exemplary terms unless limited by the claims. In addition, it may be understood by those of ordinary skill in the art that various modifications, combinations, and changes may be made according to design conditions and factors within the scope of the appended claims or equivalents thereof.

The global path generation method for a wide-area off-road environment according to one or more embodiments may divide an occupancy grid map into a plurality of tile maps and manage them, thereby reducing a communication load and the use of a memory.

The global path generation method for a wide-area off-road environment according to one or more embodiments may convert the occupancy grid map into a distance map through distance transformation to reflect the size of the unmanned vehicle, thereby setting an area in which the unmanned vehicle moves in a part having no interference with an obstacle.

The global path generation method for a wide-area off-road environment according to one or more embodiments may form one global map by connecting boundary lines of tile maps converted into the distance map, thereby generating the optimal global path on the entire global map.

Moreover, the global path generation method for a wide-area off-road environment according to one or more embodiments may connect a node-link map of each tile map through an edge node, thereby enabling path planning between tile maps through a boundary portion between the tile maps.

Furthermore, the global path generation method for a wide-area off-road environment according to one or more embodiments may easily generate the optimal global path through a series of sequences for connecting a plurality of links between start coordinates and destination coordinates.

Effects of the disclosure are not limited to the effects mentioned above, and other effects not mentioned will be clearly understood by those of ordinary skill in the art from the detailed description and description of the claims.

While the present disclosure has been particularly shown and described with reference to exemplary embodiments thereof, it will be understood by those of ordinary skill in the art that the present disclosure is not limited to the same configurations and operations as the specific embodiments described above, and various changes in form and detail may be made therein without departing from the spirit and scope of the present disclosure as defined by the following claims. Therefore, the scope of the present disclosure is defined not by the detailed description of the invention but by the following claims, and all differences within the scope will be construed as being included in the present disclosure.

What is claimed is:

1. A global path generation method for a wide-area off-road environment in which an unmanned vehicle performs autonomous driving, the global path generation method comprising:
generating an occupancy grid map for a driving area through a sensor;
converting the occupancy grid map into a distance map;
generating a plurality of nodes by sampling unit grids, the unit grids being randomly and uniformly distributed in the driving area of the distance map;
generating a plurality of links connecting the plurality of nodes;
receiving a destination position of the unmanned vehicle; and
generating a global path by connecting optimal links for arriving at the destination position among the plurality of links.

2. The global path generation method of claim 1, wherein the distance map comprises a drivable area, an obstacle area, and a collision area formed between the drivable area and the obstacle area.

3. The global path generation method of claim 2, wherein the plurality of links do not overlap the obstacle area and the collision area.

4. The global path generation method of claim 1, wherein the sampled unit grid is a unit grid at a position that secures at least a preset safety distance from an obstacle by reflecting a size of the unmanned vehicle.

5. The global path generation method of claim 1, further comprising storing, in a data storage, length information of the plurality of links and a minimum distance among connection distances of the plurality of links when the plurality of links pass through at least one node.

6. The global path generation method of claim 1, further comprising forming one global map by connecting of a plurality of distance maps in a tile form including up, down, left, and right boundary lines.

7. The global path generation method of claim 6, further comprising:
forming a plurality of boundary nodes by sampling unit grids, the unit grids being randomly and uniformly distributed among grids spanning a boundary line, in drivable areas of the plurality of distance maps; and
connecting, by a link of the plurality of links through a boundary node of the plurality of boundary nodes, one node formed in a drivable area of the distance map in the tile form among the plurality of distance maps to another node formed in a drivable area of another distance map connected to the distance map through the boundary line.

8. The global path generation method of claim 1, wherein the receiving of the destination position of the unmanned vehicle and the generating the global path by connecting of the optimal links for arriving at the destination position among the plurality of links comprises:
defining, as a cost, a distance from a start node to a goal node via a current node;
adding the start node and one or more nodes linked to the start node to a first list;
selecting a node having a least cost from the first list and setting the selected node as the current node;
removing the current node from the first list and adding the current node to a second list in a state in which the current node is not the goal node;
skipping the one or more nodes linked to the current node in a state in which the one or more nodes linked to the current node is in the second list;
adding the one or more nodes linked to the current node to the first list setting the cost, and setting a parent node of one or more nodes linked to the current node as the current node, in a state in which the one or more nodes linked to the current node is not in the first list; and
updating the cost and setting the parent node as the current node in a state in which the one or more nodes linked to the current node is in the first list and the cost of passing through the current node is less than a cost of passing through another node.

9. The global path generation method of claim 8, further comprising setting a node closest to the destination position as the goal node.

10. The global path generation method of claim 8, further comprising setting a node closest to a start position of the unmanned vehicle as the start node.

11. The global path generation method of claim 8, further comprising determining whether the first list is empty and terminating a process without generating the global path in a state in which the first list is empty and the goal node is not determined.

12. The global path generation method of claim 8, further comprising generating, as the global path, a path from the start node to the goal node in a state in which the current node is the goal node.

13. A global path generator for a wide-area off-road environment in which an unmanned vehicle performs autonomous driving, comprising:
a memory storing instructions; and
at least one processor configured to execute the instructions to:
generate an occupancy grid map for a driving area through a sensor;
convert the occupancy grid map into a distance map;
generate a plurality of nodes by sampling unit grids, the unit grids being randomly and uniformly distributed in the driving area of the distance map;
generate a plurality of links connecting the plurality of nodes;
receive a destination position of the unmanned vehicle; and
generate a global path by connecting optimal links for arriving at the destination position among the plurality of links.

14. The global path generator of claim 13, wherein the distance map comprises a drivable area, an obstacle area, and a collision area formed between the drivable area and the obstacle area, and
wherein the plurality of links do not overlap the obstacle area and the collision area.

15. The global path generator of claim 13, wherein the sampled unit grid is a unit grid a position that secures at least a preset safety distance from an obstacle by reflecting a size of the unmanned vehicle.

16. The global path generator of claim 13, wherein the at least one processor is further configured to execute the instructions to store, in a data storage, length information of the plurality of links and a minimum distance among connection distances of the plurality of links when the plurality of links pass through at least one node.

17. The global path generator of claim 13, wherein the at least one processor is further configured to execute the instructions to:
form one global map by connecting of a plurality of distance maps in a tile form including up, down, left, and right boundary lines;
form a plurality of boundary nodes by sampling unit grids, the unit grids being randomly and uniformly distributed among grids spanning a boundary line, in drivable areas of the plurality of distance maps; and
connect, by a link of the plurality of links through a boundary node of the plurality of boundary nodes, one node formed in a drivable area of the distance map in the tile form among the plurality of distance maps to another node formed in a drivable area of another distance map connected to the distance map through the boundary line.

18. The global path generator of claim 13, wherein in the receiving of the destination position of the unmanned vehicle and the generating the global path by connecting of the optimal links for arriving at the destination position among the plurality of links, the at least one processor is further configured to execute the instructions to:
define, as a cost, a distance from a start node to a goal node via a current node;
add the start node and one or more nodes linked to the start node to a first list;
select a node having a least cost from the first list and setting the selected node as the current node;
remove the current node from the first list and add the current node to a second list in a state in which the current node is not the goal node;
skip the one or more nodes linked to the current node in a state in which the one or more nodes linked to the current node is in the second list;
add the one or more nodes linked to the current node to the first list, set the cost, and set a parent node of one or more nodes linked to the current node as the current node in a state in which the one or more nodes linked to the current node is not in the first list; and
update the cost and set the parent node as the current node in a state in which the one or more nodes linked to the current node is in the first list and the cost of passing through the current node is less than a cost of passing through another node.

19. The global path generator of claim 18, wherein the at least one processor is further configured to execute the instructions to:
set a node closest to the destination position as the goal node; and
set a node closest to a start position of the unmanned vehicle as the start node.

20. The global path generator of claim 18, wherein the at least one processor is further configured to execute the instructions to:
determine whether the first list is empty and terminating a process without generating the global path in a state in which the first list is empty and the goal node is not determined; and
generate, as the global path, a path from the start node to the goal node in a state in which the current node is the goal node.
